(19) United States
(12) Patent Application Publication
(10) Pub. No.: US 2023/0390641 A1
(43) Pub. Date: Dec. 7, 2023

(54) TOY SYSTEM FOR MULTIPLAYER SOCIAL PLAY

(71) Applicant: LEGO A/S, Billund (DK)

(72) Inventors: Sisse HAGENSBY, Billund (DK); Simon Lund LARSEN, Billund (DK); Rune DEGETT, Billund (DK); Michael SCHMIDT, Billund (DK); Stephen MORRIS, Billund (DK); Philip Kongsgaard DØSSING, Billund (DK); Jesper SØDERBERG, Billund (DK); Sven Dominik BRACHMANSKI, Aachen (DE)

(21) Appl. No.: 18/249,669

(22) PCT Filed: Nov. 10, 2021
(86) PCT No.: PCT/EP2021/081176

§ 371 Date: Apr. 19, 2023

(30) Foreign Application Priority Data
Nov. 16, 2020 (DK) PA202070755

(51) Int. Cl. A63F 13/5375; A63F 13/847; A63F 13/47; A63F 13/798

(52) U.S. Cl. CPC A63F 13/5375; A63F 13/847; A63F 13/47; A63F 13/798; A63F 13/46

(57) ABSTRACT

A toy system for use in a social play experience. The toy system has a plurality of toy construction elements and a data processing system configured to store a hierarchical task structure. The task structure defines dependencies between a plurality of tasks, a subset of which include construction of respective toy construction assemblies. The data processing system is configured to select one or more tasks and assign to respective play participants. The selection and/or assignment of the one tasks is based at least in part on the dependencies between the plurality of tasks. The data processing system is configured to present, to each play participant to whom a task has been assigned, the corresponding assigned task and receive user-input indicative of a completion of the respective assigned tasks, and repeat until a play completion trigger is fulfilled.

### CROSS-REFERENCE TO RELATED APPLICATIONS

The present application is a U.S. National Stage Application of International Application No. PCT/EP2021/081176, filed on Nov. 10, 2021 and published on May 19, 2022 as WO 2022:101233 A1, which claims the benefit and priority of Danish Patent Application No. 202070755, filed on Nov. 16, 2020, each of which is incorporated herein by reference in its entirety for any purpose whatsoever.

### FIELD OF THE DISCLOSURE

The disclosure relates to toy systems for multiplayer social play activities. The toy system may be a toy construction system comprising construction elements with coupling members for detachably interconnecting construction elements.

### BACKGROUND

Toy systems and, in particular, toy construction systems have been known for decades. In particular, toy construction systems comprising modular toy elements having coupling members for detachably interconnecting the modular toy elements with each other have gained high popularity. The simple building blocks have been supplemented with dedicated toy elements with a mechanical or electrical function to enhance the play value. Such functions include e.g. motors, switches and lamps.

More recently, toy systems have been proposed that combine physical toy construction elements with a computer-implemented experience.

It is generally desirable to engage multiple play participants in a social play experience to enhance the interactive experience and to enhance the entertainment value.

Generally, it remains desirable to provide a close integration of physical toys of the toy system and a computer-generated play experience.

It is further generally desirable to provide a toy system that facilitates play across multiple age groups and/or otherwise across heterogeneous groups of play participants.

It is also generally desirable to provide a toy system that is suitable for children and/or other user groups without a detailed understanding of programming techniques, control systems, or the like.

It is also generally desirable to enhance the educational and/or play value of toy systems.

At least some embodiments of the toy system and other aspects disclosed herein seek to address one or more of the above problems and/or other problems.

### SUMMARY

Disclosed herein are embodiments of a toy system adapted for use in a social play experience, the toy system comprising a plurality of toy construction elements and a data processing system, the data processing system being configured to:
a) store a data structure defining a task structure, in particular a hierarchical task structure, the task structure comprising a plurality of tasks, and the task structure defining dependencies between the plurality of tasks; wherein at least a subset of the tasks comprise construction of respective toy construction assemblies from respective pluralities of the toy construction elements;
b) select one or more tasks from the plurality of tasks and assign the selected one or more tasks to respective one or more play participants chosen from the plurality of play participants; wherein selection and/or assignment of the one or more tasks is based at least in part on the dependencies between the plurality of tasks;
c) present, to each play participants to whom a task has been assigned, the corresponding assigned task;
d) receive user-input from the one or more play participants indicative of a completion of the respective assigned tasks;
e) repeat steps b) through d) until a play completion trigger is fulfilled.

Accordingly, embodiments of the toy system disclosed herein provide a social play activity wherein play participants may collaborate around building one or more physical toy construction models and, optionally, around otherwise engaging with one or more constructed toy construction models. The toy system provides a play activity that includes a real-world physical activity of constructing one or more physical toy construction elements. The play activity further includes a digital portion implemented by the data processing system. The tasks are tasks to be performed by the play participants and the plurality of tasks include one or more physical construction tasks where one or more play participants construct one or more toy construction models. The toy construction assemblies may include one or more complete toy construction models and/or part models, i.e. partial toy construction models that are subsequently to be completed by adding one or more further toy construction elements and/or one or more other part models. Individual construction tasks or subtasks may thus be assigned to respective play participants. For example, the building instructions for a toy construction model may be divided into subsequences of building steps and at least some of the tasks may comprise performing one of the subsequences of building steps.

In some embodiments, the data processing system is further configured to label the completed tasks of the task structure as completed; and selection and assignment of tasks comprises selecting and assigning only tasks not labeled as completed. To this end, the data processing system may be configured to store, e.g. as a part of the task structure, a task status attribute indicative of a current status of the task.

In some embodiments, selection and assignment of a first task to a first play participant is based at least in part on one or more selection criteria. The one or more selection criteria may be selected from:
an age of the first play participant,
a skill level of the first play participant,
a preference of the first play participant,
an identity, type and/or attribute of an avatar selected or assigned to the play participant.

To this end, the data processing system may be configured to store respective user profiles of the play participants, each user profile representing profile information, such as an age, a skill level and/or one or more user preferences.

In some embodiments, the data processing system is configured to:
determine at least one observable metrics indicative of a play behavior of a first play participant when performing one or more of the tasks;
base the selection of a subsequent task to be performed by the first play participant at least in part on the determined at least one observable metrics.

Accordingly, the system is capable of “learning” how to select and assign the tasks to the respective play participants and to adapt to the participant's skills and/or preferences.

In some embodiments, the observable metrics is selected from:
an elapsed time between presentation of a task to the first participant until receipt of a user-input from the first play participant indicative of a completion of the selected task.
an attribute indicative of a usage pattern of task guidance provided by the data processing system via the user-interface. Task guidance may be provided in the form of sequential, step-by-step instructions allowing the play participant to be presented with user-selected steps. An attribute of a usage pattern may include a number of times the play participant moved backwards in the step-by-step instructions, a measure of a change of speed of progression when performing the steps of the step-by-step instructions. Other examples of attributes may include other recorded user-interface operations performed by the play participant while performing an assigned tasks.

In some embodiments, selection and assignment of a task may at least in part be based on a user selection. e.g. by a play participant selecting a task to be assigned to himself-herself and/or by a play participant selecting a task to be assigned to another play participant. For example, such selection may be a selection among a number of tasks automatically selected by the data processing system, e.g. based on the play participants attributes, the task dependencies and/or the like.

In some embodiments, assigning a task to a play participant comprises the data processing system labelling the task as “in progress”, and selection and assignment of tasks comprises selecting and assigning only tasks not labeled as “in progress”, in particular only tasks neither labelled “in progress” nor “completed”. To this end, each task of the task structure may have a status attribute associated to it, the status attribute being indicative of a current status of the task, e.g. “not started”, “in progress” and “completed”.

In some embodiments, each of the plurality of tasks comprises construction steps in which toy construction elements are interconnected to each other. It will appreciated, however, that some embodiments of the toy system may include tasks that comprise other steps or subtasks, different from construction steps. Some tasks may include such other subtasks in addition to construction steps. In some embodiments, some tasks may even be entirely non-construction tasks, i.e. they include only steps of subtasks other than construction steps. Hence, in such embodiments, only a subset of the plurality of tasks comprises construction steps in which toy construction elements are interconnected to each other.

Examples of such other, non-construction subtasks may include one or more of the following:
creating a narrative, a song, a drawing, and/or another tangible or intangible product, e.g. involving one or more previously constructed toy construction models;
performing a play activity involving one or more previously constructed toy construction models;
capturing an image or video of one or more previously constructed toy construction models, e.g. using a digital camera of a mobile phone, tablet or other electronic device;
uploading a digital representation of one or more previously constructed toy construction models into a digital environment.

Presenting an assigned task to the play participant to whom the task has been assigned may be performed in a number of ways. In particular the data processing system may display, or otherwise present, task instructions or guidance explaining to the play participant what task to perform, optionally including an explanation or other guidance as to how to perform the task. When the task is or includes a construction task for creating an assembly of toy construction elements, presenting the assigned task to the play participant may include displaying, or otherwise presenting, building instructions to the play participant, e.g. as a sequence of representations, in particular graphical and/or animated representation, of respective construction steps. The data processing system may provide a user interface allowing the play participant to view the sequence of representation at a user-selected speed, e.g. by allowing the play participant to move to a subsequent representation of the sequence and/or to revisit a previous representation of the sequence. Alternatively or additionally, the building instructions may be interactive in a different manner.

In some embodiments, the task dependencies are configured to impose a task execution order where each task of the plurality of tasks is associated with none, one or more predecessor tasks of the plurality of tasks; and selection and assignment of tasks comprises selecting and assigning only tasks having no uncompleted predecessor tasks. Here the term predecessor task refers to an immediate sequential order, i.e. to tasks having to be performed directly before the current task without any intermediate task having to be performed between the predecessor task an d the current task. Nevertheless, it will be understood, that the predecessor task itself may have other predecessor tasks.

For example, some or even all tasks may result in a tangible or intangible task output, and a task output from a predecessor task may be required as an input to a successor task, thus imposing a task execution order. Examples of task outputs include one or more of the following: a part model of a toy construction model; a toy construction model; a digital representation of a toy construction model, a narrative, a part of a narrative, a song, a part of a song, etc. It will be appreciated, that some task outputs can only be used as task input to a single successor task while other types of task output may be usable as task input to multiple successor tasks. For example, a physical part model of a toy construction model can only be used as direct input to a single successor building step, while a narrative, a digital representation of a toy construction model or a play activity may serve as input to one or more successor tasks.

The task structure may be represented as a tree structure, representing nodes and edges, each edge connecting two nodes, each node representing a task and each edge representing a task dependency. The nodes will also be referred to task nodes. In particular, each edge may be a directed edge connecting a task node and a predecessor task node, thus being indicative of the predecessor task node representing a predecessor task of the task represented by the task node. Nodes not having any predecessor nodes may be denoted leaf nodes of the tree, while nodes without any successor nodes may be denoted root nodes.

In some embodiments, the plurality of tasks include a plurality of interrelated construction tasks, each of the interrelated construction task representing a set, e.g. a sequence, of one or more construction steps of a construction process for constructing a toy construction model. For example, one or more of the interrelated construction tasks may comprise construction of respective part models of a toy construction model and/or adding additional toy construction elements to a previously constructed part model and/or assembling two or more previously constructed part models to form a larger part model or to form a final toy construction model. In such embodiments, each of the interrelated construction tasks may be a predecessor to none or only one successor task of the plurality of interrelated construction tasks. However, each of the interrelated construction tasks may have none, one or more than one predecessor tasks of the plurality of interrelated construction tasks. Accordingly, in such a social play activity, play participants may collaborate around building a toy construction model where individual construction tasks or subtasks are assigned to respective play participants. For example, the building instructions for the toy construction model may be divided into subsequences of building steps and each of the interrelated construction tasks comprises one of the subsequences. At least some of the subsequences, e.g. all but a final subsequence, may result in a respective part model. When completed, the part models may be assembled in a final construction step into a complete toy construction model. Other examples of social construction activities may include construction of multiple toy construction model, e.g. a city including multiple buildings.

For many toy construction models it may be difficult to design the toy construction model in a way that it can be assembled from part models such that the part models have similar complexity, e.g. in terms of the number or type of toy construction elements included in the part model or in terms of the number or complexity of the construction steps required to construct the part model. Accordingly, when the selection and assignment of the construction steps are based on selection criteria indicative of attributes of the respective play participants, an entertainment experience can be provided even for complex models and/or heterogeneous groups of play participants.

In some embodiments, each task may have one or more attributes associated with it. The attributes may be stored as part of the task structure. Each of the one or more attributes may be selected from:
a target age group indicating an age group for which performance of the task is suitable,
a target skill level, indicative of a level of skill required for performing the task,
a complexity parameter indicative of a complexity of the task, e.g. a number of subtasks, a target duration for performing the task, etc.
a type of task, e.g. construction task, decoration task, creative task (such as creating a part of a narrative involving one or more of the constructed toy construction models, or the like).

Selection and assignment of the tasks may thus be based on the task attributes and/or on corresponding attributes and/or preferences of the play participants. In particular, the data processing system may be configured to select a task for assignment to a play participant such that the task attributes of the selected task match the user attributes of the play participant.

The data processing system may be configured to assign an avatar to each of the play participants. The avatar may be user-selected or it may be assigned partly or completely automatically. Each avatar may have one or more avatar attributes associated to it, e.g. an age group, a skill level, one or more preference attributes, etc. The preference attributes may indicate a preference to certain types of tasks, e.g. construction tasks, creative tasks, etc.

The data processing system may, responsive to an observed play behavior of the associated play participant associated with the avatar, update one or more of the avatar attributes of the avatar, e.g. one or more preference attributes, a skill level, etc.

The play completion trigger may include one or more triggers, e.g. triggers selected from:
a user input indicative of a desire to end play
an elapsed time
completion of all or a predetermined fraction of tasks of the plurality of tasks
completion of a predetermined task of the plurality of tasks
achievement of a predetermined play goal.

In some embodiments, the data processing system may be configured to assign a play score to one or more of the play participants, e.g. to one or more individual play participants or to an entire group of play participants. The data processing system may compute the play score based on a number of tasks performed by a play participant, the type (e.g. complexity) of tasks, the time spent for performing the tasks, and/or the like. A play score may be indicative of a rating or level of success of individual play participants or groups of play participants. A play score may be in the form of an in-game currency, a ranking and/or the like. The play score may subsequently be used to determine a skill level of a user and/or to level-up a user and/or the like. A play score may also be used to allow a user to unlock features of a game, such as new play experiences or new features. The data processing system may be configured to update one or more attributes associated with the play participant, e.g. attributes of an avatar associated with the play participant responsive to the play score.

In some embodiments, assignment of a first task to a first play participant may comprise:
identifying one or more, in particular all, predecessor tasks of the first task;
providing information to one or more play participants, e.g. the one or more play participants having performed the one or more predecessor tasks and/or the first play participant to which the first task has been assigned, allowing any task output of the one or more predecessor tasks to be made available to the first play participant to which the current task is assigned.

In some embodiments the data processing system may notify each play participant having completed a predecessor task of the assigned first task to make respective task outputs of the predecessor tasks available to the first play participant, e.g. by informing the play participants having completed the predecessor tasks about the identity of the first play participant and/or other information enabling the play participants having completed the predecessor tasks to make the corresponding task outputs available to the first play participant. For example, this may be done by the method disclosed in co-pending international patent application PCT/EP2020/063449, the entire contents are hereby incorporated herein by reference.

Alternatively or additionally, the data processing system may notify the first play participant as to which task outputs from predecessor tasks are required as input to the first task. The data processing system may further notify the first play participant about which play participants have performed the predecessor tasks or otherwise provide information enabling the first play participant to obtain the required task outputs from the predecessor tasks.

In some embodiments, the social play experience comprises populating a virtual play environment with virtual objects. In particular, at least a first task of the plurality of tasks may comprise constructing a toy construction model from the toy construction elements, creating a digital representation of the constructed toy construction model and adding the digital representation to a virtual play environment. It will be appreciated that these steps may be part of a single task or divided into two or more tasks. Creating a digital representation may comprise capturing one or more images of the constructed toy construction model and creating a digital representation from the captured one or more images, e.g. as described in WO 2015/185629. It will be appreciated, however, that the data processing system may use any suitable mechanism for identifying or recognizing a constructed toy construction model. e.g. by a suitable contactless detection mechanism, e.g. based on radio-frequency signals, optical detection and/or another detection technology. Optical detection may include recognition of visible characteristics of the toy construction model using image processing technology, recognizing a tag or other visible code applied to or included in the toy construction model, and/or the like. Other detection mechanisms may include detection, by an RFID reader, of an RFID tag included in the toy construction model.

In some embodiments, the social play experience comprises creating a physical play environment from physical toy construction models. In particular, at least a first task of the plurality of tasks may comprise constructing a toy construction model from the toy construction elements, and positioning the constructed toy construction model in a physical play environment, e.g. relative to previously constructed toy construction model. It will be appreciated that these steps may be part of a single task or divided into two or more tasks.

Yet further, in some embodiments, the social play experience comprises populating a mixed virtual-digital play environment. In particular, at least a first task of the plurality of tasks may be performed by a first play participant who operates a first user device. The first task may comprise the first play participant constructing a first toy construction model from the toy construction elements, positioning the constructed first toy construction model in a first physical play environment, creating, using the first user device, a first digital representation of the constructed first toy construction model and sharing the first digital representation with a second user device of a second game participant.

For example, the first and second user devices may be operable in a common multiplayer game session. The first user device may be configured to capture video images of the first physical play environment including the constructed first toy construction model to display the captured video images as a primary view of the first physical play environment. The second user device may be configured to display a secondary view of a scene corresponding to the first physical play environment as seen from a secondary view point. The secondary view of a scene may be a view of a virtual environment including the first digital representation or an augmented-reality view of a second physical play environment augmented with the first digital representation, e.g. as described un US 2020:0265646. Similarly, the first user device may display a live view of the first physical play environment augmented by a second digital representation of a second toy construction model. The second toy construction model may be a toy construction model constructed by the second, or by a third, play participant, e.g. as a part of a second task of the plurality of tasks. The second or third play participant may thus have created a digital representation of the second toy construction model using a second (or third) user device of the second (or third) play participant and have shared the second digital representation with the first user device for display in an augmented reality view of the first play environment. Accordingly multiple play participants may engage in a social play activity without having to be in the same location. Instead, they can share digital representations of their creations and engage in a multi-user augmented-reality social play experience. Sharing digital representations may be implemented by communicating the digital representations between the participating user devices or by sharing information allowing the respective user devices to retrieve the digital representation, e.g. from a repository of known or previously generated digital presentations.

In some embodiments, the social play experience may comprise additional tasks including virtual or physical play activities in the constructed virtual, augmented or physical play environment.

The data processing system may include one or more user devices, e.g. multiple user devices for operation by respective play participants. Each user device may comprise a processing unit, a user interface including a display and, optionally, an image capturing device. Each user device is thus adapted for receiving input from a play participant and to provide user-perceptible output to the play participant.

The data processing system may include multiple user devices, all being operable to join a common multiplayer social play session. According to some embodiments, one or more of the user devices is an augmented-reality (AR) device configured to display a primary view of a physical play environment augmented with computer-generated content, e.g. digital representations of toy construction models constructed by other play participants. According to some embodiments, one or more of the user devices is a virtual-reality (VR) device configured to display a computer-generated view of a virtual scene, e.g. a virtual scene that corresponds to the first physical play environment such as a virtual replica of the first physical play environment.

Advantageously in some embodiments, a user device may be one of a smartphone, a tablet computer, and a head-mountable display, a desktop computer, a laptop computer, each suitably programmed to implement or participate in the social play experience.

According to some embodiments, the first user device is configured to identify said constructed first toy construction model, e.g. among a set of pre-determined toy construction models. For example, this may be done using the technique disclosed in WO 2016/075081. Advantageously, the first digital representation is provided on the basis of said identification, preferably as a digital representation of the identified toy construction model.

According to some embodiments, the user devices of respective play participants may be operable to communicate directly with each other in a common multiplayer game session. According to some embodiments, the user devices of respective play participants are operable to communicate through a host system in a common multiplayer game session. The host system may be a networked computer configured to provide networked access to a multiplayer game environment for multiple user devices. The host system may be implemented as a remote and/or distributed system, such as a cloud-based data processing system. The host system may be configured to host a multiplayer game session for the user devices. The host system may store, and execute, game code. The host system may further store information related to the social play experience, such as the task structure, information about the respective play participants, avatars and/or the like.

According to some embodiments, multiplayer game session processing may occur at one of the user devices and/or at a host system included in, or cooperating with, the toy system to provide a multiplayer game environment.

For the purpose of the present description, a toy construction model is a coherent structure constructed from two or more toy construction elements. A toy construction element is a single coherent element that cannot be disassembled in a nondestructive manner into smaller toy construction elements of the toy construction system. A toy construction model or toy construction element may be part of a larger structure, e.g. a larger toy construction model, while still being individually recognizable. A toy construction model or element recognized or recognizable by a user device in a captured image refers to a toy construction model or element that is individually recognized or recognizable, regardless as to whether the toy construction model or element is captured in the image on its own or as part of a larger toy construction model. For example, the user device may be configured to recognize partial toy construction models at different stages of construction. If the play participant builds e.g. a wall that will be part of a bigger building, the user device may be operable to recognize the wall as a partial toy construction model and the complete building as the completed toy construction model.

The present disclosure relates to different aspects including the toy system described above and in the following, corresponding apparatus, systems, methods, and/or products, each yielding one or more of the benefits and advantages described in connection with one or more of the other aspects, and each having one or more embodiments corresponding to the embodiments described in connection with one or more of the other aspects and/or disclosed in the appended claims.

In particular, according to one aspect, disclosed herein is a computer-implemented method, in particular a method for implementing a social play experience, the method comprising:
a) storing a data structure defining a task structure, in particular a hierarchical task structure, the task structure comprising a plurality of tasks, and the task structure defining dependencies between the plurality of tasks; wherein at least a subset of the tasks comprise construction of respective toy construction assemblies from respective pluralities of the toy construction elements;
b) selecting one or more tasks from the plurality of tasks and assigning the selected one or more tasks to respective one or more play participants chosen from the plurality of play participants; wherein selection and/or assignment of the one tasks is based at least in part on the dependencies between the plurality of tasks;
c) presenting, to each play participants to whom a task has been assigned, the corresponding assigned task;
d) receiving user-input from the one or more play participants indicative of a completion of the respective assigned tasks;
e) repeating steps b) through d) until a play completion trigger is fulfilled.

Furthermore, a data processing system is provided that is configured, e.g. by suitable program code stored on the data processing system, to perform the steps of one or more of the computer-implemented methods explicitly described or implicitly disclosed herein.

Yet further, a computer program product is provided comprising program code adapted to cause, when executed on a data processing system, the data processing system to perform the steps of one or more of the computer-implemented methods explicitly described or implicitly disclosed herein.

The computer program product may be provided as a computer-readable medium, such as a CD-ROM. DVD, optical disc, memory card, flash memory, magnetic storage device, floppy disk, hard disk, etc. In other embodiments, a computer program product may be provided as a downloadable software package, an App, or the like. e.g. on a web server for download over the internet or other computer or communication network. In particular, an embodiment of a toy construction set may include toy construction elements, and installation instructions for installing a computer program product on a suitable data processing system.

### BRIEF DESCRIPTION OF THE DRAWINGS

FIGS. 1-3 each show a prior art toy construction element.

FIG. 4 schematically shows an embodiment of a toy system as disclosed herein.

FIG. 5 schematically shows an embodiment of a toy system as disclosed herein.

FIG. 6 illustrates a computer-implemented process implementing a social play experience.

FIG. 7 schematically illustrates operation of an example of a toy system.

FIG. 8 schematically illustrates operation of another example of a toy system.

### DETAILED DESCRIPTION

Various aspects and embodiments of toy systems disclosed herein will now be described with reference to modular toy construction systems comprising toy construction elements in the form of bricks. However, the disclosure may be applied to other forms of toy construction elements.

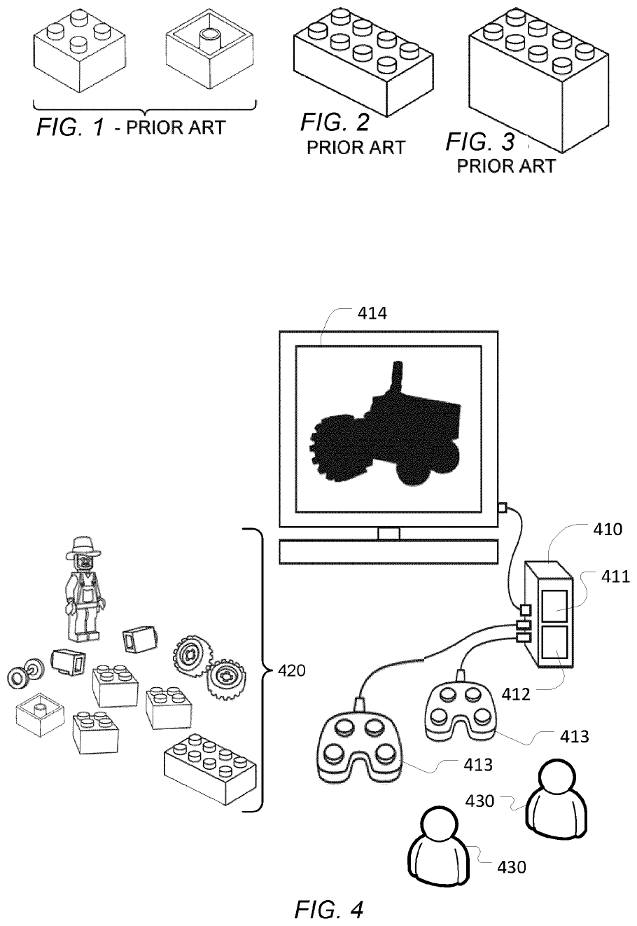

FIG. 1 shows a toy construction element with coupling pegs on its top surface and a cavity extending into the brick from the bottom. The cavity has a central tube, and coupling pegs on another brick can be received in the cavity in a frictional engagement as disclosed in U.S. Pat. No. 3,005,282. FIGS. 2 and 3 show other such prior art toy construction elements. The toy construction elements shown in the remaining figures have this known type of coupling members in the form of cooperating pegs and cavities. However, other types of coupling members may also be used in addition to or in-stead of the pegs and cavities. The coupling pegs are arranged in a square planar grid, i.e. defining orthogonal directions along which sequences of coupling pegs are arranged. The distance between neighboring coupling pegs is uniform and equal in both directions. This or similar arrangements of coupling members at coupling locations defining a regular planar grid allow the toy construction elements to be interconnected in a discrete number of positions and orientations relative to each other, in particular at right angles with respect to each other. The toy construction elements shown here, in FIGS. 1-3, are of the passive type, without additional functionality beyond mechanical model building, such as electromagnetic, electronic, optical, or the like. However, some embodiments of toy construction sets may also include active toy construction elements that are configured to perform user-perceptible functions. e.g. emit light, sound, import motion, etc.

FIG. 4 schematically shows an embodiment of a toy system as disclosed herein. The toy system is adapted for use in a social play activity. The toy system comprises a data processing system 410 and a plurality of toy construction elements 420. A plurality of play participants 430 may use the toy system to engage in the social play activity.

In the example of FIG. 4, the data processing system is depicted as a game console. However, in other embodiments, the data processing system 410 may be a personal computer, a desktop computer, a laptop computer, a handheld computer such as a tablet computer, a smartphone or the like, a handheld entertainment device, or any other suitably programmable computer. The data processing system 410 comprises a processing unit 411 such as a Central Processing Unit (CPU) and one or more data storage devices 412 such as a memory, a hard disk, and/or the like.

The data processing system is connected to a display 414 and to one or more user input devices 413, such as game controllers.

The display 414 is operatively coupled to the data processing system 410. The data processing system 410 is configured to display play-related information on the display 414, e.g. in the form of respective graphical representations. Though illustrated as separate components in FIG. 4, it will be appreciated that the display may be integrated in the housing of the data processing system 410.

The input devices 413 are operatively coupled to the data processing system 410 and are configured to receive user inputs from play participants 430. In the example of FIG. 4, the input devices are illustrated as game controllers. It will be appreciated that alternative examples of input devices include a keyboard, a mouse, or other pointing device, and/or the like. In some embodiments, as illustrated in FIG. 4, the toy system comprises an input device for each play participant 430, in other embodiments, two or more play participants may share an input device. Though illustrated as separate components in FIG. 4, it will be appreciated that an input device may be integrated in the data processing system 410 and/or in the display 414, e.g. in the form of a touch screen of a tablet computer. It will be appreciated that the system may comprise further peripheral devices, e.g. an RFID reader, a digital camera and/or the like, which may be operatively coupled to, such as integrated into, the data processing system 410.

The display 414 and the one or more input devices 413 may be operationally coupled to the data processing system 410. For example one or more of the above devices may be coupled to the data processing system via a suitable wired or wireless input interface of the data processing system 410. Examples of wired connection include wired connections via a serial or parallel port of the data processing system, such as a USB port. Examples of wireless connections include Bluetooth, Wifi or another suitable wireless communications interface. Alternative, one or all of the devices may be integrated into the data processing system. For example, the data processing system 410 may comprise an integrated display and/or input device. In particular, tablet computers and smartphones typically comprise an integrated touch screen operable as a display and input device.

The data storage device 412 has stored thereon a computer program, e.g. an App or other software application. The computer program is adapted, when executed by the processing unit 411, to cause the data processing system 410 to execute a digital part of the social play experience. The data storage device 412 has further play-related data stored thereon, including a task structure, data indicative of plurality of tasks, user data, data indicative of a state of the play experience, user scores, etc. It will be appreciated that, in some embodiments, the data processing system 410 may be communicatively connected to a host system, e.g. via the Internet or another suitable computer network. At least a part of the processing described herein may then be performed by the host system. Alternatively or additionally, the data processing system 410 may be communicatively connected to other, e.g. remote, data processing systems, e.g. systems similar to the one shown in FIG. 4. Accordingly, play participants 430 may engage in an online multi-player social game experience with play participants operating another, remote data processing system. For example, the social play experience may comprise creating, and/or otherwise engaging with, a multi-player online virtual world populated by virtual objects. The virtual objects may be created based on digital representations of constructed toy construction models, constructed by the play participants 430 as part of the social play experience. Accordingly, in some embodiments, a host system may generate and simulate a virtual environment, such as a virtual world which may be accessible by multiple play participants from respective client computers. A play participant may use a client computer executing a suitable program to recognize a constructed toy construction model and cause the client or the host system to create a corresponding virtual object. Recognition of a constructed toy construction model may be performed using a variety of techniques. For example, the data processing system may include, or be operationally coupled to, an RFID reader, and one or more toy construction elements of the toy construction model may include an RFID tag identifying the model. Alternatively, the data processing system may include, or be operationally coupled to, a digital camera, and the data processing system may be configured to recognize the toy construction model based on a captured image of the toy construction model, captured by the digital camera. The recognition may be based on known object recognition techniques, optionally using visually recognizable tags. Yet further, the data processing system may be configured to create a virtual object based on a digital representation of an arbitrary toy construction model, i.e. without having to recognize the toy construction model as one of a plurality of known models. To this end, the data processing system may comprise a system for acquiring a 3D representation of an object. e.g. as described in WO 2018/095789.

The host system may then add the virtual object to the virtual world and control the virtual object within the virtual world.

The toy construction elements 420 may be of the type described in connection with FIGS. 1-3 or of another suitable type. It will be appreciated that a toy system may include any number of construction elements. In the example of FIG. 4, one of the toy construction elements 420 has the shape of a building block as described in connection with FIG. 1, and another construction element has the shape of a human figure while other toy construction elements have the shape of a wheel. Each construction element has coupling members—in this example pegs and cavities—for attachment to one or more other toy construction elements toy elements allowing a play participant to construct a toy construction model comprising multiple construction elements.

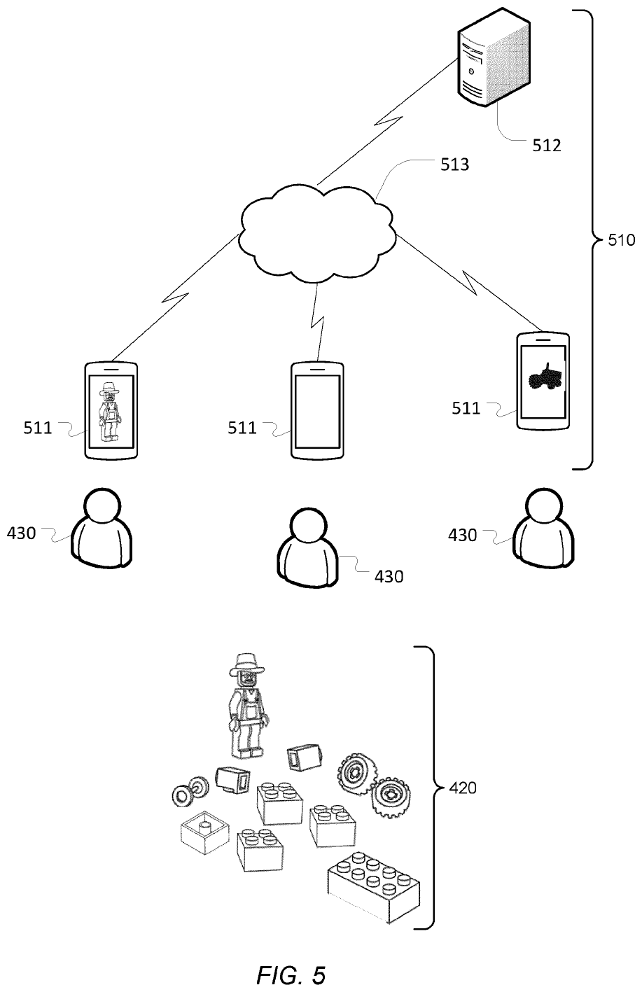

FIG. 5 shows schematically another embodiment of a toy system as disclosed herein. The toy system is adapted for use in a social play activity and comprises a data processing system 510 and a plurality of toy construction elements 420. A plurality of play participants 430 may engage in the social play activity. The toy system of FIG. 5 is similar to the toy system of FIG. 4 and only differs in that the data processing system 510 is a distributed data processing system comprising multiple user devices 511. In the example of FIG. 5 each play participant 430 operates a respective user device 511. However it will be appreciated that, in alternative embodiments, two or more play participants may share a user device.

The user devices 511 are each operable to join in a common multiplayer social play session. For example, each user device 511 may have stored thereon a social play App executing a social play digital game application. Examples of a user device include a personal computer, a desktop computer, a laptop computer, a handheld computer, a tablet computer, a game console, a handheld entertainment device, a smart phone, or any other suitably programmable computer. Each user device may comprise a display, an input device, a processing unit and a data storage device, e.g. all as described in connection with FIG. 4.

The data processing system further comprises a host system 512, and the user devices 511 are communicatively connected to the host system 512, e.g. via a suitable communications network 513, e.g. a local network, such as a piconet or other ad-hoc wireless network, or a wide area network, such as the internet, a cellular communications network, and/or the like. The user devices may be connected to the host system via wired and/or wireless connections, such as using Bluetooth. WiFi, a cellular telecommunications network and/or another suitable communications technology. Though the host system 512 of FIG. 5 is depicted as a computer different from the user devices 511, it will be appreciated that, in some embodiments, one of the user devices may be operable as a host system, in particular as both host system and user device. In other embodiments, the host system may be a remote host server, a cloud service, and/or the like.

During operation, each user device 511 may execute a computer program such as an app. The computer program may comprise, or have access to, a database. The data base may have stored thereon information associated with one or more play activity. In particular, for each play activity, the database may have stored thereon a task structure including a plurality of tasks and their task dependencies. Each task may have associated with it task instructions, e.g. a representation of a toy construction model, or a part model to be constructed as part of the task. The presentation may include building instructions, such as graphical, animated and/or interactive building instructions. Each task may have associated with it one or more task attributes, e.g. a target ager range, a target skill level, an expected task duration, a task type, etc. The task structure may be stored as a suitable data structure, e.g. a tree structure.

The computer program may provide a user interface allowing a first play participant to operate a first user device of the user devices 511 to select and initiate a social play activity. For example, the first user device may establish a server process so as to operate as host server of the play session. The first user device may establish the server process locally and execute the server process on the first user device. Alternatively, the first user device may communicate with a remote host system to cause the remote host system to establish the server process.

The server process initiates the selected play activity, including corresponding play-related information. The play-related information includes a task structure associated with the play experience, e.g. virtual building instructions for constructing a toy construction model. The building instructions are divided into a plurality of tasks, each for constructing respective part models and/or for assembling constructed part models to larger part models or to the final toy construction model. The server process is further adapted to maintain the task structure during the play experience, e.g. by maintaining status attributes associated with the respective tasks. The user devices of all play participants may access the play-related information from the host server, e.g. via a local network such as a wireless LAN.

In some embodiments, the server process may initially estimate the completion time for each task, e.g. based on the number of elements and/or part models to be assembled and an assumed average assembly speed. Alternatively, the estimated completion times may be predetermined and pre-stored as part of the task structure. The server process may determine a sequence of assembly steps on a “critical path” and estimate an expected completion time for completion of the assembly.

Each play participant may use one of the user devices to execute a corresponding application program and join the social play activity. The user device may provide a user interface allowing the play participant to join the play session and/or to enter or select user information. For example, the user may enter his/her age, a skill level, user preferences (e.g. a preference for technical tasks or decorative parts, a preference for assembling larger part models, etc.) and/or the like. The user may select an avatar or be automatically assigned an avatar, e.g. based on user attributes or based on a previously selected avatar.

Based on the number of toy construction elements and/or part models to be assembled in one task and based on the self-assessment of the play participants and/or otherwise determined attributes of the play participants, the server process may estimate the individual completion time for each task that is available for being performed.

The server process may then select a set of initial tasks for assignment to respective play participants. During the initial tasks, only individual toy construction elements are to be assembled, i.e. no output of previous assembly tasks is required as input to the initial tasks. The initial tasks may be represented as leaf nodes of a tree structure, i.e. as nodes having no predecessors.

The server process may then assign tasks to the individual play participants. The assignment may be based on the types of tasks, task attributes and on the corresponding attributes of the play participants. For example, the server process may assign tasks according to the respective age groups, skill levels and/or user preferences for respective task types. In one embodiments, the server process may assign tasks that lie on the critical path to play participants having a high skill level; it may assign tasks involving smaller numbers of assembly steps to play participants having a low skill level; or it may assign tasks involving only large toy construction elements to play participants of low age groups. For example, the server process may select multiple suggested tasks for each user. The suggested tasks may be displayed on the respective user devices and the individual play participants may select one of the suggested tasks, which are then assigned to them.

The server process marks each of the assigned tasks as “in progress” so as to avoid that the same task is assigned to multiple users.

The user devices display the toy construction elements required for completion of the respective tasks and may even display corresponding building instructions. Each play participant may thus construct a part model to be subsequently assembled to larger toy construction model. Subsequent tasks may thus use the output of their respective predecessor tasks as inputs. To this end, the user device operated by the play participant performing a subsequent task may display one or more required part models which have been constructed in respective predecessor task. The user device may further display the name or avatar of the play participant having performed the predecessor task. The server process also causes the user device of the play participant having performed the predecessor task to make the part model available, e.g. by handing it over, to the play participant to which the corresponding successor task has been assigned.

In some embodiments, the server process may monitor actual completion times of the individual tasks and/or other play behavior of the individual play participants and automatically update the attributes of the individual play participants based on the observed behavior. For example, the server process may automatically update the skill level based on the actual completion times and/or on observed interaction with interactive building instructions. Alternatively or additionally, the process may automatically adapt user preferences based on the selected tasks a play participant has selected from a set of suggested tasks.

In an alternative embodiment, the play participants access, e.g. via a standard web browser, an interactive website provided by a host system without installing their own application on their respective user devices.

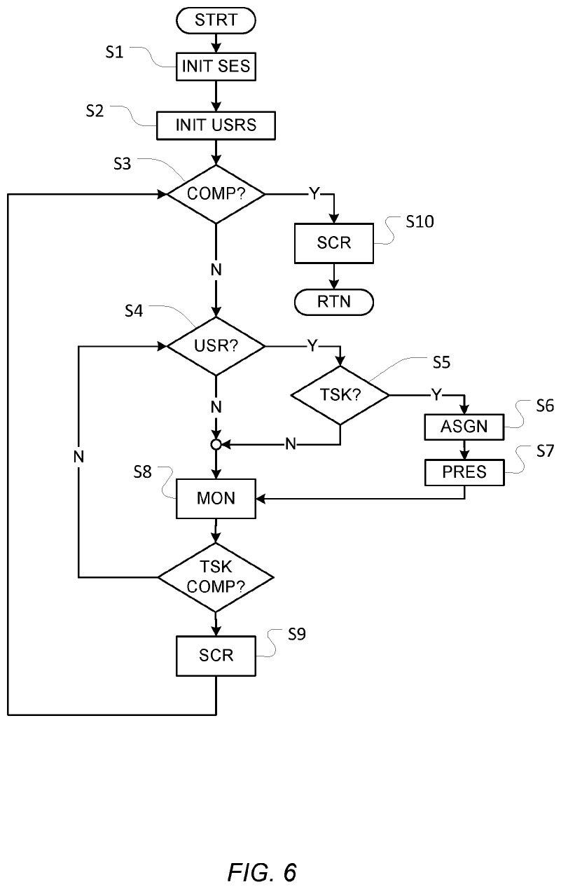

FIG. 6 illustrates a flow diagram of an embodiment of a process implemented by a toy system described herein, e.g. the toy system of FIG. 4 or 5.

In an initial step S1, the process initiates a play session and the corresponding data structures.

In step S2, a plurality of users join the play session and the process initiates the respective user profiles, e.g. including their skill level, age group, avatar, etc.

In step S3, the process determines whether a termination criterion for ending the play experience has been fulfilled. Examples of termination criteria may include one or more of the following: elapse of a predetermined period of time, completion of all tasks of a task structure, a user input, etc. If the termination criteria has not yet been fulfilled, the process proceeds at step S4: otherwise the process proceeds at step S10.

At step S4, the process determines whether all users have currently assigned a task and if the assigned tasks are still in progress. If there are users who are not currently working on a task, the process proceeds at step S5; otherwise, the process proceeds at step S8.

At step S5, the process determines whether there are uncompleted tasks that are available for execution, i.e. uncompleted tasks that either have no predecessor tasks on which they depend, or tasks where all predecessor tasks have already been completed.

The process then selects a task from the available task to be assigned to the user who is not currently working on a task. If there are currently no available tasks, or no tasks that match the user profile of the user waiting for a task, the process proceeds at step S8; otherwise, the process proceeds at step S6.

At step S6, the process assigned the selected task to the user waiting for a task and marks the assigned task as being “in progress”. In subsequent step S7, the process presents the task to the play participant, including relevant information for task completion. e.g. building instructions, a list of construction elements and/or part models required for the task, optionally including information about which play participant has constructed the required part models. The process may further send a notification to any play participant having constructed part models required for the present parts, informing them to make the respective part models available to the current play participant.

In subsequent step S8, the process monitors the performance of the tasks that are currently in progress. In particular, the process monitors whether one or more tasks have been completed (e.g. based on user-input). The process may monitor the time elapsed since the individual tasks have been assigned. The process may even collect further metrics indicative of user behavior, e.g. interaction patterns with interactive building instructions.

If the process determines. e.g. based on a user input, that one of the tasks has been completed, the process proceeds at step S9; otherwise the process returns to step S4 to assign further tasks to play participants who may be waiting for being assigned a task.

At step S9, when a task has been reported completed, the process updates the task structure accordingly, i.e. by marking the task as completed. The process may further evaluate the collected metrics, and update a score or even attributes of the play participant based on the observed metrics. The process then returns to step S3 to determine whether a termination criterion is fulfilled.

At step S10, when a termination criterion has been fulfilled, the process may compute a final play score, e.g. for the entire group and/or for individual play participants. The process may award rewards to the group and/or play participants, update user profiles and/or user avatar profiles, e.g. based on the observed task completion metrics. The process may then terminate. For example, the process may return to a main menu allowing selection of a new play experience.

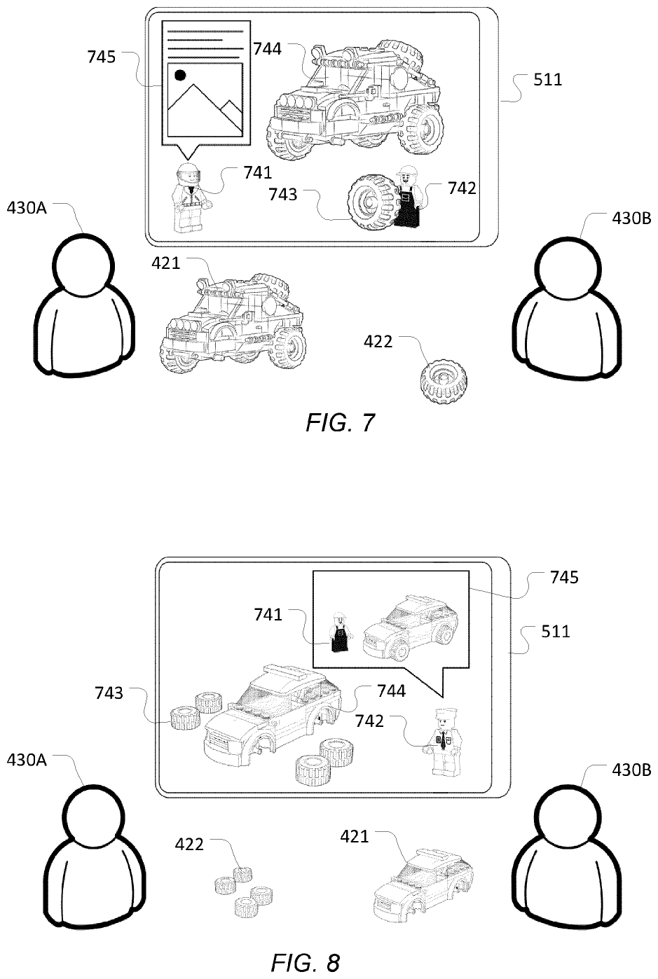

FIG. 7 schematically illustrates operation of an example of a toy system. The toy system is adapted for use in a social play activity and comprises a data processing system and a plurality of toy construction elements. A plurality of play participants 430A, B may engage in the social play activity. The toy system of FIG. 7 is similar to the toy system of FIG. 5 and only differs in that the data processing system only comprises a single user device 511, e.g. a smartphone or tablet, shared by the play participants 430A and 430B. However, it will be appreciated that other embodiments of the toy system may include more than one user device as described in connection with FIG. 5.

In the example of FIG. 7, the play participants have already constructed a part of a toy construction model 421 from a plurality of toy construction elements. In this example, the part model 421 is a car having a missing front wheel. However, it will be appreciated that other embodiments may involve other types of toy construction models. The user device 511 executes an App, which provides a user interface and executes a social play experience. In the example of FIG. 7, the App has assigned a task to play participant 430B. The assigned task involves adding a wheel-shaped toy construction element 422 to the part model 421. To this end, the App displays instructions 745 on the display of the user device 511, the instructions 745 instructing play participant 430B to add the wheel 422 to the part model 421. At the same time, the App instructs play participant 430A to make the part model 421 available to play participant 430B so as to allow play participant 430B to add the missing wheel 422. In this example, the instructions are provided as a narrative representing a storyline where each play participant has an associated avatar occurring in the storyline. Avatar 741 of play participant 430A represents a rally driver who wants to use a car 744 to participate in a rally contest. Avatar 742 of play participant 4308 represents a car mechanic. To this end, at the beginning of the play experience each of the play participants may have selected one of the avatars or the app may have automatically assigned the avatars to the respective play participants, e.g. based on known user profiles of the play participants, e.g. including user information such as age, preferences, construction skill level etc. Each avatar may have associated with it a corresponding skill level, preferences etc. The App may then assign tasks to the avatars according to a predetermined storyline and/or tasks that match the skill level of the respective avatars. For example, play participant 430B of the mechanic avatar 742 may predominantly get assigned construction steps for constructing the toy car 421, or at least the more complicated construction steps. Play participant 430A may get assigned tasks that involve play activities such as driving the toy car 744 or otherwise playing out parts of the storyline. The App may be configured to provide the instructions in the form of a narrative, e.g. where the rally driver avatar 741 tells the mechanic that he needs off-road tires because he wants to drive in the mountains.

FIG. 8 schematically illustrates operation of another example of a toy system. The example of FIG. 8 is similar to the example of FIG. 7 in that play participants 430A and 430B share a user device 511 which executes an App providing a digital part of a social play experience. The system further comprises toy construction elements which are already partly assembled to a toy construction model 421 but where some toy construction elements 422 are still unassembled. The play participants each have an avatar 741, 742, respectively, associated with them and the App provides instructions related to an assigned task in the form of a narrative. In this example, the narrative involves a police car 744 that needs new tires 743 and the avatars represent a police officer 742 and a mechanic 741.

In the claims enumerating several means, several of these means can be embodied by one and the same element, component or item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components or groups thereof.

What is claimed is:

1. A toy system adapted for use in a social play experience, the toy system comprising a plurality of toy construction elements and a data processing system configured to:
store a data structure defining a task structure, in particular a hierarchical task structure, the task structure comprising a plurality of tasks, and the task structure defining dependencies between the plurality of tasks; wherein at least a subset of the tasks comprise construction of respective toy construction assemblies from respective pluralities of the toy construction elements;
select one or more tasks from the plurality of tasks and assign the selected one or more tasks to respective one or more play participants chosen from the plurality of play participants; wherein selection and/or assignment of the one or more tasks is based at least in part on the dependencies between the plurality of tasks;
present, to each play participants to whom a task has been assigned, the corresponding assigned task;
receive user-input from the one or more play participants indicative of a completion of the respective assigned tasks; and
repeat steps b) through d) until a play completion trigger is fulfilled.

2. A toy system according to claim 1, wherein the data processing system is further configured to label the completed tasks in the task structure as completed; and to select and assign only tasks not labeled as completed.

3. A toy system according to claim 1, wherein selection and assignment of a first task to a first play participant is based at least in part on one or more selection criteria selected from:
an age of the first play participant,
a skill level of the first play participant,
a preference of the first play participant, and
an identity, type and/or attribute of an avatar selected or assigned to the play participant.

4. A toy system according to claim 1, wherein the data processing system is configured to:
determine at least one observable metrics indicative of a play behavior of a first play participant when performing one or more of the tasks; and
base the selection of a subsequent task to be performed by the first play participant at least in part on the determined at least one observable metrics.

5. A toy system according to claim 4, wherein the observable metrics is selected from:
an elapsed time between presentation of a task to the first participant until receipt of a user-input from the first play participant indicative of a completion of the selected task; and
an attribute indicative of a usage pattern of task guidance provided by the data processing system via the user-interface.

6. A toy system according to claim 1, wherein assigning a task to a play participant comprises the data processing system labelling the task as “in progress”, and selection and assignment of tasks comprises selecting and assigning only tasks not labeled as “in progress”, in particular only tasks neither labelled “in progress” nor “completed”.

7. A toy system according to claim 1, wherein the data processing system is configured to present task guidance, in particular building instructions, to the play participant.

8. A toy system according to claim 1, wherein at least one task of the plurality of tasks comprises creating a digital representation of a constructed toy construction model and embedding the created digital representation in a virtual environment accessible to at least some of the play participants.

9. A computer-implemented method, comprising the steps of:
storing a data structure defining a task structure, in particular a hierarchical task structure, the task structure comprising a plurality of tasks, and the task structure defining dependencies between the plurality of tasks; wherein at least a subset of the tasks comprise construction of respective toy construction assemblies from respective pluralities of the toy construction elements;
selecting one or more tasks from the plurality of tasks and assigning the selected one or more tasks to respective one or more play participants chosen from the plurality of play participants; wherein selection and/or assignment of the one tasks is based at least in part on the dependencies between the plurality of tasks;
presenting, to each play participants to whom a task has been assigned, the corresponding assigned task;
receiving user-input from the one or more play participants indicative of a completion of the respective assigned tasks;
repeating steps b) through d) until a play completion trigger is fulfilled.

10. (canceled)

11. A data processing system for providing a social play activity, the data processing system having a computer processor configured to execute the steps of:
providing a database having stored thereon virtual building instructions for constructing a toy construction model, the virtual building instructions divided into a plurality of tasks;
assigning the plurality of tasks to play participants for completion based on play participant attributes;
receiving user-input from the play participants indicative of completion of the respective assigned tasks; and
triggering a play completion criteria.

12. The data processing system according to claim 11, wherein the database further has stored thereon task dependencies and task instructions.

13. The data processing system according to claim 11, wherein the computer processor is further configured to execute the step of receiving play participant attributes from each play participant via user-input prior to assigning the plurality of tasks to play participants.

14. The data processing system according to claim 11, wherein the computer processor is further configured to execute the steps of:
determining a metric indicative of a play behavior of a play participant when performing an assigned task; and
assigning a subsequent task to be performed by the play participant at least in part on the determined metric.

15. The data processing system according to claim 14, wherein the metric is selected from:
an elapsed time between assigning of a task to the play participant until receipt of user-input from the play participant indicative of a completion of the respective assigned tasks; and
an attribute indicative of a usage pattern of task guidance provided by the computer processor via a user-interface.

16. The data processing system according to claim 14, wherein at least one task of the plurality of tasks includes creating a digital representation of a constructed toy construction model and embedding the created digital representation in a virtual environment accessible to a play participant.
